(19) United States
(12) Patent Application Publication
(10) Pub. No.: US 2005/0286377 A1
(43) Pub. Date: Dec. 29, 2005

(54) Record carrier having a main file system area and a virtual file system area

(75) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLEIJKE PHILIPS ELECTRONICS, N.V., EINDHOVEN (NL)

(21) Appl. No.: 10/533,724

(22) PCT Filed: Oct. 14, 2003
(86) PCT No.: PCT/IB03/04560

§ 371 Date: May 3, 2005

(30) Foreign Application Priority Data
Nov. 7, 2002 (EP) 02079654.6

(51) Int. Cl. G11B 15/52; G11B 5/09; G11B 7/00

(52) U.S. Cl. 369/53.2; 369/47.1; 369/275.1

(57) ABSTRACT

The present invention relates to a recordable record carrier having a user area (UA) for storing user data and a management area (MA) for storing management data. The invention further relates to a recording apparatus for recording information on such a record carrier and a corresponding recording method. In some applications it is useful to translate the main file system into an alternative virtual file system. To reduce the mount times and power consumption needed for reconstruction of the virtual file system, it is proposed that the management area (MA) comprises a main file system area (70) for storing main file system data (mFS), a virtual file system area (71) for storing virtual file system data (vFS) in a raw format, and an indicator area (72) for storing an indicator (ID) indicating whether the main system data (mFS) and the virtual file system data (vFS) are mutually consistent. Only if the indicator (ID) indicates an inconsistency does the virtual file system data (vFS) need to be reconstructed from the main file system data (mFS) when the virtual file system data (vFS) is required by an application. Otherwise, the virtual file system data (vFS) can be directly retrieved from the record carrier without reconstruction.

The present invention relates to a recordable record carrier having a user area for storing user data and a management area for storing management data. The invention further relates to a recording apparatus for recording information on such a recordable record carrier and a corresponding recording method. The invention further relates to a computer program for implementing said methods. In particular, the present invention relates to an optical record carrier such as a small form factor optical (SFFO) disc.

In some applications it is useful to translate the file system used on a recordable record carrier into another file system that can be exposed across a standard interface to a host that does not understand the original file system, which will be called main file system in the following, but that does understand the other file system, which will be called virtual file system in the following. An example is the mounting of a rewritable SFFO disc which uses a universal disc format (UDF) file system in a CompactFlash II (CFII) form factor drive that exposes a file allocation table (FAT) file system to the host. In the following, recordable shall mean that information can be stored on the record carrier once or several times, i.e. rewritable record carriers shall be covered by this term as well.

Typically, some structures or parts of the exposed file system will be static, for instance those containing volume descriptions and basic parameters, and some other structures or parts will be volatile, for instance those detailing directories and the allocation of files. The static parts of the exposed virtual file system can be cached to the record carrier without problems. They may be put, for instance, in a dedicated file in the management data area However, caching the volatile part of the exposed virtual file system on the record carrier is not straightforward. Many hosts and applications will not be aware of the fact that there are instances in which (part of) the address space is exposed from the drive to the outside world using an alternative (virtual) file system. In addition, it is also very often not desired that the hosts and applications are aware of this, because otherwise users and software developers could take it for granted and the host would be expected to act accordingly, i.e. maintain all associated structures. If one of the hosts or applications updates the main file system on the record carrier, the cached virtual file system, in particular its volatile parts, will be inconsistent with the main file system on the record carrier.

Reconstructing the directory structure for the virtual file system, without further measures, is always a time and power consuming task. It is therefore an object of the present invention to provide a recordable record carrier, a recording apparatus for recording information thereon, and a corresponding recording method wherein the required time, processing and record carrier access as well as power consumption can be dramatically reduced.

This object is achieved according to the present invention by a recordable record carrier as claimed in claim 1, whose management area comprises
a main file system area for storing main file system data of a main file system,
a virtual file system area for storing virtual file system data of a virtual file system in raw format, and
an indicator area for storing an indicator indicating whether the main system data and the virtual file system data are consistent.

This object is further achieved by a recording apparatus as claimed in claim 8, comprising
recording means for recording main file system data of a main file system in a main file system area of said management area, virtual file system data of a virtual file system in raw format in a virtual file system area of said management area, and an indicator indicating whether the main file system data and the virtual file system data are consistent in an indicator area of said management area,
reading means for reading said user data and said management data,
memory means for storing said virtual file system data,
conversion means for converting said main file system data into said virtual file system data and vice versa for storage on the record carrier and/or for output to an external host device if said indicator indicates an inconsistency between the main file system data and the virtual file system data, and
an interface for communicating with a host device.

A recording method for recording information on a record carrier on which originally only main file system data are stored is defined in claim 11 and comprises the steps of:
reading main file system data of a main file system stored in a main file system area of said management area,
converting said main file system data into said virtual file system data for storage on the record carrier and/or for output to an external host device,
storing said virtual file system data in a virtual file system area of said management area in raw format,
storing an indicator indicating whether the main system data and the virtual file system data are consistent in an indicator area of said management area.

A recording method for recording information on a record carrier on which main file system data as well as virtual file system data are stored is claimed in claim 12 and comprises the steps of:
reading an indicator, which indicates whether main file system data of a main file system stored in a main file system area of said management area and virtual file system data of a virtual file system stored in raw format in a virtual file system area are consistent, from an indicator area of said management area,
reading said main file system data from said main file system area and reconstructing at least part of said virtual file system data from said main file system data if said indicator indicates a inconsistency,
reading at least part of said virtual file system data from said virtual file system area, and
exposing the virtual file system data to an external host device.

The present invention is based on the idea to define and store an indicator on the record carrier indicating whether main system data and virtual file system data, which are both stored on the record carrier in particular areas, are consistent or not. If the virtual file system is mounted and the main file system was updated since the last time the structures of the virtual file system were cached, the virtual file system needs to be reconstructed from the main file system stored on the record carrier. If however, the virtual file system is mounted and the main file system was not updated since the last time the structures of the virtual file system were cached, the virtual file system is completely retrieved from the record carrier. This prevents the need to reconstruct the virtual file system from the main file system, dramatically reducing time, processing and record carrier access required, and thus reduces the power consumption.

According to the invention, the virtual file system data are stored on the record carrier in a raw format. This means that the virtual file system data are stored in an optimized way to reduce the required memory space. Compared with the main file system data stored in the normal format on the record carrier, less memory space is needed since, for instance, much of the padding is removed.

The user area and the management area are not necessarily contiguous, they may be interleaved, and/or part of the management data area, e.g. the virtual file system area, may be a file in the main file system area, or the space occupied by the virtual file system data may be removed from the address space presented to the main file system.

According to a preferred embodiment, the static and volatile parts of the virtual file system data are stored in separate entities on the record carrier, in particular in a static area and a volatile area of the virtual file system area This further reduces the required time and power consumption if the indicator indicates an inconsistency between the main file system data and the virtual file system data In this case, only the volatile parts have to be reconstructed from the main file system data stored on the disc while the static parts of the virtual file system data can be retrieved from the record carrier but need not be reconstructed from the main file system data, which would have required an additional time and power consumption. If there is no inconsistency, both the static and the volatile parts of the virtual file system data are retrieved from the record carrier, and no reconstruction from main file system data is required.

Tracking whether the main file system data has been updated can be implemented by several measures. According to a preferred embodiment, the indicator comprises the last update date of the main file system data and of the virtual file system data Comparing the dates will reveal whether the cached virtual file system data, or at least the cached volatile parts thereof, are still valid or whether there is an inconsistency. According to an alternative embodiment, as claimed in claim 4, a flag is set at the time of updating and caching of the virtual file system data, which flag indicates that the virtual file system data are valid. This flag is updated or reset when the main file system data are updated independently, but not the virtual file system data, thus indicating that the virtual file system data are invalid and that there is a high risk of an inconsistency.

Preferably, the indicator area is present in a location on the record carrier that is easily accessible to the drive. Such locations include, for instance, a disc navigation (DN) area, the logical volume integrity descriptor (LVID), or a chip in the record carrier, for instance a chip in disc. For instance, the last update date of the main file system data may be retrieved from the time stamp of the LVID, and the indicator may be stored in the ImplementationUse field in the ImplementationUse area of the LVID. The LVID is a structure specific to UDF. The LVID will automatically be updated even by a non-aware UDF implementation.

According to another preferred embodiment, the virtual file system area further comprises a directory area for storing the directory structure of the virtual file system. Since reconstructing the directory structure can be a time and power consuming task, this considerably reduces the time involved in retrieving and using the virtual file system data This directory information in this form is not part of the original specification of the virtual file system, neither is the directory information written using the main file system present on the record carrier in this format optimized for use with the virtual file system. The location of these data may need to be faked by mapping it on top of the main file system structures which are not accessed directly by the virtual file system. This measure is also of benefit if the virtual file system data are isolated from the main file system data, i.e. if the virtual file system data are located in a dedicated image. The virtual file system data may be in a file in the user area described by the main file system. Foreign file systems, e.g. the virtual file system, may be embedded in a file of another file system, e.g. of the main file system. This file is usually called an image.

The present invention is preferably applied to an SFFO disc which preferably uses a UDF file system as its main file system and a FAT file system as its virtual file system. When applying the invention, all data needed for browsing the SFFO disc without actually accessing files is cached, thus dramatically improving mount times and the power required to mount the virtual file system, especially if the UDF was not updated or is not relevant, in the case of a dedicated virtual file system image. In this latter case the files in the virtual file system area are not specified separately in UDF. In addition, the proposed invention enables the exposure of the virtual file system in an optimal way without putting any burden on the main file system.

The invention will now be explained in more detail with reference to the drawings, in which

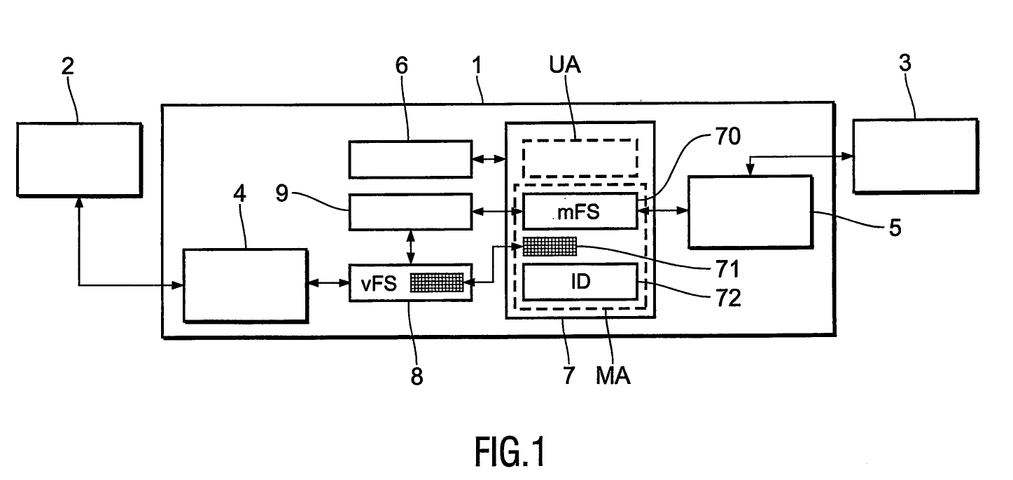

FIG. 1 shows a block diagram of a recording apparatus according to the present invention,

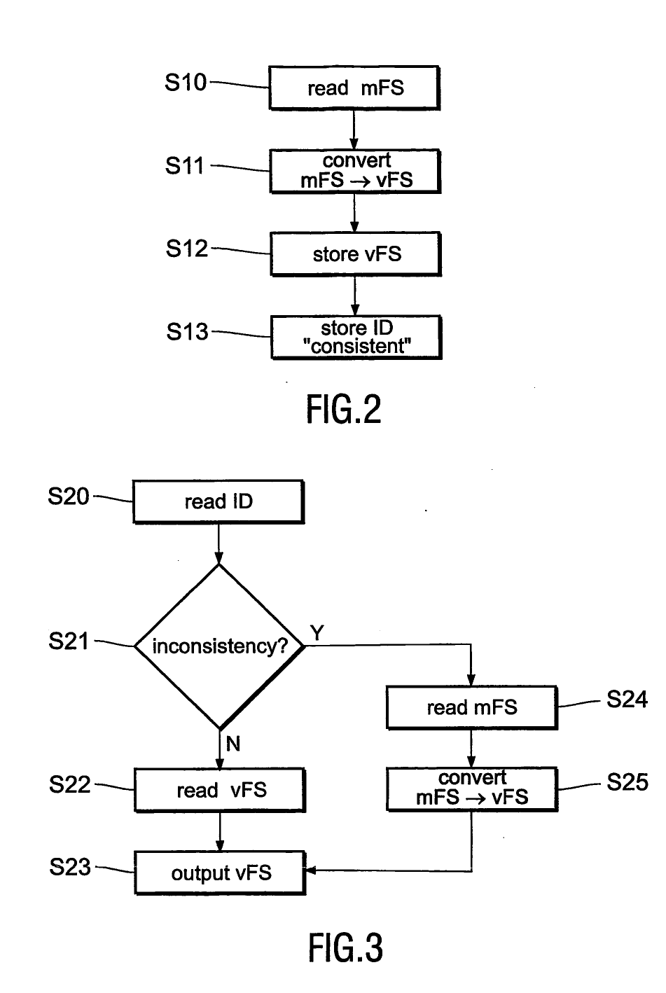

FIG. 2 shows a flow chart of a first embodiment of the recording method according to the present invention,

FIG. 3 shows a flow chart of another embodiment of a recording method according to the present invention,

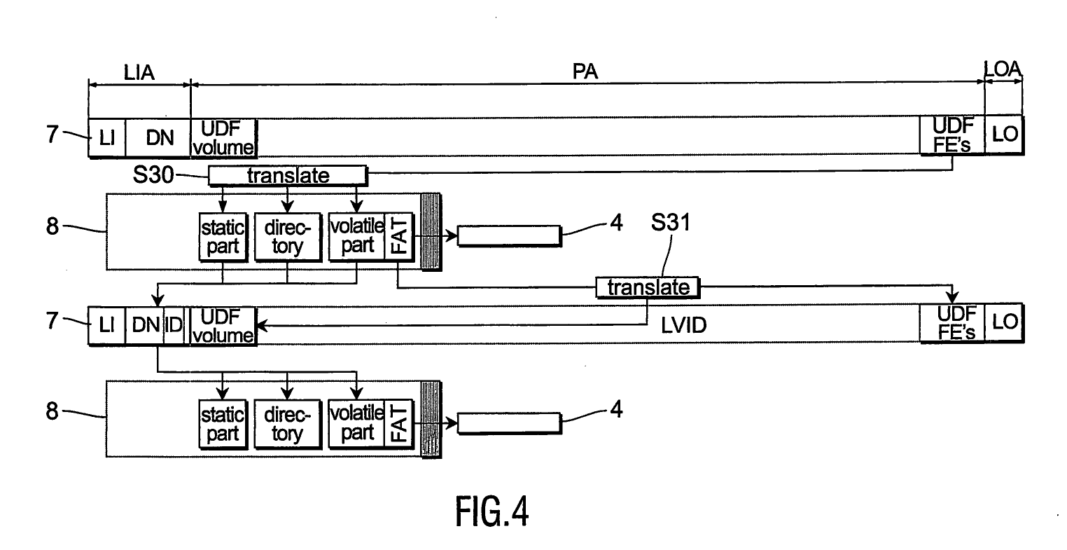

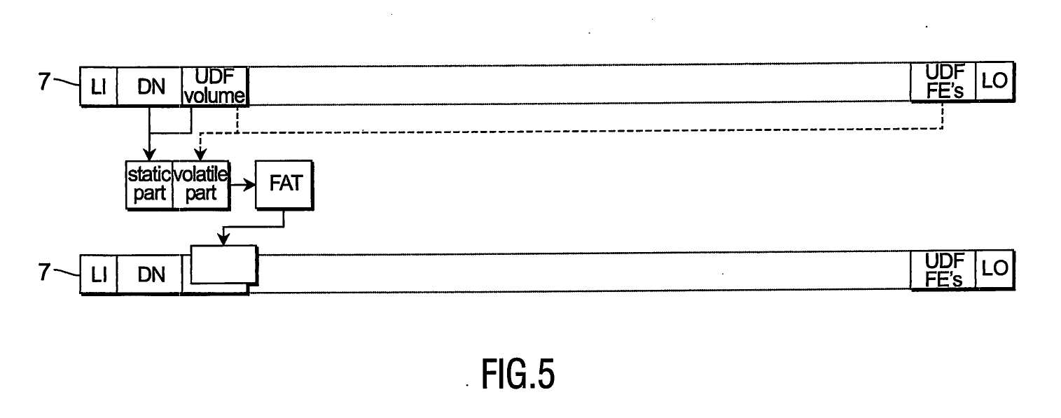

FIG. 4 shows a disc and memory layout and the steps of the recording method according to the present invention, and

FIG. 5 shows the disc layout and the steps of another embodiment of the recording method.

FIG. 1 shows a recording apparatus 1 according to the present invention to which two host devices 2 and 3 are connected. The recording apparatus 1 comprises interfaces 4 and 5 for communication with said host devices 2, 3. Furthermore, the recording apparatus 1 comprises recording and reading means 6 for recording information on a recording medium 7 and for reading information from said medium 7, e.g. an optical disc. Said medium 7 has a user area UA for storing user data and a management area MA for storing management data. It generally uses a main file system mFS, e.g. a UDF file system, which is stored in a main file system area 70. Via the interface 5, e.g. an ATAPI interface, host devices 3 capable of interpreting the main file system mFS can communicate with the recording apparatus 1 and use the recording medium 7.

For legacy host devices, however, such as host device 2, which cannot interpret the main file system, an additional virtual file system vFS is required for communication between the host device 2 and the recording apparatus 1 via the interface 4, which is, for instance, a CFII interface. Such virtual file system data vFS are stored in memory means 8 in the recording apparatus 1. A conversion unit 9 is provided in the recording apparatus 1 for conversion of the main file system data mFS stored on the record carrier 7 into the virtual file system data vFS stored or to be stored in the memory unit 8 or vice verse Thus, the virtual file system data vFS, for instance FAT file system data, can be exposed across the interface 4 to the host device 2.

At least a portion of the virtual file system data vFS is also stored on the record carrier 7 in a particular virtual file system area 71. This is generally not the virtual file system itself but information derived from it or virtual file system data in a raw format. Such raw data do not enable the host device 2 to use the virtual file system for accessing the record carrier 7, but are provided on the record carrier to optimize the conversion process from the main file system to the virtual file system. Furthermore, the stored part of the virtual file system generally does not cover all of the files on the record carrier at all times as the main file system does. A distinction is preferably made between volatile and non-volatile data of the virtual file system data vFS.

Still further, an indicator ID is additionally stored on the record carrier 7 in a particular indicator area 72. This indicator ID is used to indicate whether the main file system data mFS and the virtual file system data vFS are consistent or not.

The function of the recording apparatus 1 and the recording method according to the present invention will now be explained in more detail. FIG. 2 shows a flow chart of a first embodiment of a recording method. In a first step S10, main file system data mFS which are already provided on the record carrier are read therefrom. Such main file system data mFS are then converted in step S11 into virtual file system data vFS if the record carrier 7 is mounted for the first time in the recording apparatus 1. Such virtual file system data vFS are stored in the subsequent step S112 in memory 8 as well as, at least partly, on the record carrier 7 in a virtual file system area 71. Finally, in step S13, the indicator D indicating in this case consistency between the main file system and the virtual file system is stored in the indicator area 72.

Another embodiment of the recording method according to the present invention, which takes into account that virtual and main file system data are already stored on the record carrier, is shown in the flow chart of FIG. 3. In a first step S20, the indicator ID is read from the record carrier and evaluated in step S21. If the indicator ID indicates that the main file system data mFS and the virtual file system data vFS are mutually consistent, the virtual file system data vFS are completely read from the record carrier (S22) and outputted (S23) so that a host device using the virtual file system can access the record carrier.

If the indicator ID indicates an inconsistency in step S21, at least part of the main file system data mFS is read (S24) from the record carrier and subsequently converted (S25) into virtual file system data vFS which are finally again outputted (S23). Thus, the virtual file system needs to be reconstructed from the main file system only in those cases in which there is an inconsistency, which dramatically reduces time and power consumption in such cases.

FIG. 4 shows the disc layout and the memory layout and illustrates the steps of another embodiment of a recording method according to the present invention. In the first line, the layout of the logical volume of an optical rewritable disc 7 is shown. It comprises a lead-in area LIA including the lead-in LI and disc navigation data DN, a lead-out area LOA including the lead-out LO and a program area PA including user data, main file system volume structures such as a UDF volume, and main file system file entries such as UDF file entries UDF FE.

The main file system data consist of volume descriptors in a contiguous space at the beginning of the program area PA and file descriptors that can be scattered throughout the remaining program area PA, for instance interleaved with actual user data, i.e. files, or preferably in a contiguous area, which is preferably located at the end of the program area in the case of SFFO.

The user area UA and management area MA, described above and shown in FIG. 1, are not necessarily contiguous, they may be interleaved, and/or the virtual file system data area, which is part of the management data area, may be a file in the main file system data area, or the space occupied by the virtual file system data area may be removed from the address space presented to the main file system.

If the disc 7 is mounted for the first time in a FAT enabled CFII drive, the UDF, i.e. the main file system data, will be read and translated (S30) in the drive (referred to above as the recording apparatus 1) to FAT. The static parts are mainly derived from the UDF volume structures, the volatile parts are mainly derived from the UDF file entries. The obtained FAT, in particular its static part, volatile part, and directory structure, is stored in the memory 8 and can be exposed across the CFII interface 4.

Upon an unmount command of the disc the constructed FAT is translated (S31) back into the UDF and written to the disc 7. An additional indicator is stored on the disc 7, for instance in an easily accessible location, such as an indicator area ID in the disc navigation area DN, indicating whether the cached FAT is valid or not. Alternatively or in addition, the last update date for the FAT and of the UDF may be recorded on the disc 7, e.g. in the disc navigation area DN so that a comparison of these dates will reveal whether the cached FAT is still valid. Still further, said indicator may be implemented using the logical volume integrity descriptor LVID, for instance by retrieving the last update date of UDF from the time stamp in the LVID and/or by including a flag that indicates that the cached FAT is valid in the ImplementationUse field in the ImplementationUse area of the LVID.

If the UDF is supposed to cover files added during the FAT operation, the UDF on the disc 7 also needs to be updated which can, however, be delayed until the next dismount or until the next mount under UDF. If the UDF has not been changed before the next mount of FAT, it can be ignored and only the FAT memory structures stored on the disc 7 are loaded into the memory 8 as shown in the last two lines of FIG. 4.

If the UDF has been changed before the next mount of FAT, only the static part of the FAT is retrieved from the disc 7 directly, e.g. from a static area within the disc navigation area DN and/or the UDF volume, whereas the volatile part of the FAT is reconstructed from the UDF on the disc 7 as shown in FIG. 5. The FAT starts at the beginning of the storage space. The generated FAT image is then mapped over the UDF volume space as shown in FIG. 5, last line.

The drive checks the inconsistency flag. If this not raised, the drive reads the cached vFS directly into memory. If it is raised, the drive mounts the mFS, reads at least the static part of the vFS, and reconstructs the new situation for the vFS. Then the data area is exposed with FAT virtually mapped, as shown in FIG. 5, to the beginning of the address space. Physical block number 0, i.e. the beginning of the UA, is logical block number 0 within FAT. The data area of the FAT file system starts at the beginning of the UDF partition (logical block number 0 for UDF), which usually directly follows the area with the UDF volume structures. It should be noted that it is possible to change UDF without making it inconsistent with FAT, e.g. by changing an extended attribute, which is not a concept known to FAT.

The indicator may be recorded in different locations such as the disc navigation area, e.g. in a separate structure such as an indicator area, with the static parts of the virtual file system (FAT), in a chip in disc or in MRAM (magnetic random access memory) in the drive. Furthermore, the directory structure of the virtual file system may also be recorded on the disc to save time and power consumption during reconstruction of the virtual file system.

A particular implementation of the invention will now be explained. The invention may be applied on an SFFO disc which is mounted in a CFII form factor drive in a digital camera. In memory the UDF is translated into FAT, generating static FAT structures, e.g. the boot record, which are written to disc, and further generating the FAT tables and a representation of the directory structure. The drive exposes a FAT based CFII interface to the digital camera Still images are transferred from the camera to the SFFO disc. The FAT structures are updated in memory. Dirty flags indicating that the contents of the structures the dirty flags are related to are not verified or guaranteed to be consistent, are set for each added file and FAT as a whole.

If the batteries of the camera run out before the drive is ejected, no problem arises for the SFFO drive since an NVRAM, preferably MRAM, is used as the memory. As soon as the camera has new batteries, the drive will perform a consistency check. Upon dismounting of the drive, the volatile parts of FAT, in particular FAT tables and FSInfo structure, are written to disc as well as the directory information. The FAT allocation is translated into UDF structures for the new and updated files. The UDF on SFFO is updated. Part of the latter update writes the LVID. It is written in the ImplementationUse field of the ImplementationUse area of the LVID that the cached FAT is valid.

Next time the FAT is mounted it will check the LVID for the CachedValid indicator. If this is present, both the static and volatile parts of FAT are retrieved from disc, as well as the directory information. If it is not present, it means that some UDF implementation has written the LVID most recently and that the FAT and directory structures need to be reconstructed from the UDF on disc. Thus the present invention drastically reduces the mount times and energy required for mounting the virtual file system.

1. Recordable record carrier having a user area (UA) for storing user data and a management area (MA) for storing management data, said management area comprising
a main file system area (70) for storing main file system data (mFS) of a main file system,
a virtual file system area (71) for storing virtual file system data (vFS) of a virtual file system in raw format, and
an indicator area (72) for storing an indicator (ID) indicating whether the main system data (mFS) and the virtual file system data (vFS) are consistent.

2. Record carrier as claimed in claim 1, wherein said virtual file system area (71) comprises a static area for storing static parts of said virtual file system data and a volatile area for storing volatile parts of said virtual file system data (vFS) so that, if the indicator (ID) indicates an inconsistency between the main file system data (mFS) and the virtual file system data (vFS), only the volatile parts of the virtual file system data (vFS) need to be reconstructed from the main file system data (mFS).

3. Record carrier as claimed in claim 1, wherein said indicator (ID) comprises the last update date of the main file system data (mFS) and of the virtual file system data (vFS).

4. Record carrier as claimed in claim 1, wherein said indicator (ID) comprises a flag which is set when the virtual file system data (vFS) are updated, indicating that the virtual file system data (vFS) are valid, and which is reset when the main file system data (mFS) are updated independently, indicating that the virtual file system data (vFS) are invalid.

5. Record carrier as claimed in claim 1, wherein said indicator area (72) is present in an easily accessible location, in particular in a disk navigation area (DN), in a logical volume integrity descriptor (LVID), or in a chip in the record carrier (7).

6. Record carrier as claimed in claim 1, wherein said virtual file system area (71) further comprises a directory area for storing the directory structure of the virtual file system.

7. Record carrier as claimed in claim 1, wherein said main file system is a Universal Disc Format (UDF) file system, and wherein said virtual file system is a File Allocation Table (FAT) file system.

8. Recording apparatus for recording information on a recordable record carrier (7) having a user area (UA) for storing user data and a management area (MA) for storing management data, said apparatus comprising
recording means (6) for recording main file system data (mFS) of a main file system in a main file system area (70) of said management area (MA), virtual file system data (vFS) of a virtual file system in raw format in a virtual file system area (71) of said management area (MA), and an indicator (ID) indicating whether the main file system data (mFS) and the virtual file system data (vFS) are consistent in an indicator area (72) of said management area (MA),
reading means (6) for reading said user data and said management data,
memory means (8) for storing said virtual file system data (vFS),
conversion means (9) for converting said main file system data (mFS) into said virtual file system data (vFS) and vice versa for storage on the record carrier (7) and/or for output to an external host device (2, 3) if said indicator (ID) indicates an inconsistency between the main file system data (mFS) and the virtual file system data (vFS), and
an interface (4, 5) for communicating with a host device (2, 3).

9. Recording apparatus as claimed in claim 8, wherein said recording means (6) and said reading means (6) are adapted for accessing an optical disk (7), in particular a small form factor optical disk using a universal disc format, and wherein said interface (4) is adapted for communicating with a compact flash form factor drive (2) using a file allocation table system.

10. Recording apparatus as claimed in claim 8, wherein said memory means (8) comprise a MRAM unit.

11. Recording method for recording information on a recordable record carrier (7) having a user area (UA) for storing user data and a management area (MA) for storing management data, said method comprising the steps of
reading main file system data (mFS) of a main file system stored in a main file system area (70) of said management area (MA),
converting said main file system data (mFS) into said virtual file system data (vFS) for storage on the record carrier (7) and/or for output to an external host device (2, 3),
storing said virtual file system data (vFS) in a virtual file system area (71) of said management area (MA) in raw format,
storing an indicator (ID) indicating whether the main system data (mFS) and the virtual file system (8) data (vFS) are consistent in an indicator area (72) of said management area (MA).

12. Recording method for recording information on a recordable record carrier (7) having a user area (UA) for storing user data and a management area (MA) for storing management data, said method comprising the steps of
reading an indicator (ID), which indicates whether main file system data (mFS) of a main file system stored in a main file system area (70) of said management area (MA) and virtual file system data (vFS) of a virtual file system stored in raw format in a virtual file system area (71) are consistent, from an indicator area (72) of said management area (MA),
reading said main file system data (mFS) from said main file system area (70) and reconstructing at least part of said virtual file system data (vFS) from said main file system data (mFS) if said indicator (ID) indicates an inconsistency,
reading at least part of said virtual file system data (vFS) from said virtual file system area (71), and
exposing the virtual file system data (vFS) to an external host device (2).

13. Recording method as claimed in claim 12, further comprising the steps of
setting the indicator (ID) such that it indicates an inconsistency if the virtual file system data (vFS) and/or the main file system data (mFS) are changed, and
storing the set indicator (ID) in said indicator area (72).

14. Computer program comprising computer program means for causing a computer to perform the steps of the method as claimed in claim 11 when said computer program is run on a computer.
